(19) United States
(12) Patent Application Publication
(10) Pub. No.: US 2011/0065540 A1
(43) Pub. Date: Mar. 17, 2011

(54) BELT DRIVE MECHANISM WITH BELT TENSIONER

(75) Inventors: Pai-Shien Su, Taipei (TW); Shao-Yang Wu, Taipei (TW)

(73) Assignee: FOXLINK IMAGE TECHNOLOGY CO., LTD., Taipei (TW)

(21) Appl. No.: 12/561,449

(22) Filed: Sep. 17, 2009

(51) Int. Cl. F16H 7/12

(52) U.S. Cl. 474/138

(57) ABSTRACT

A belt drive mechanism with belt tensioner has a driving pulley pivoted to a fixing frame, a driven pulley pivoted to the fixing frame, with a belt wrapping thereon, and a tensioner which has a wheel pivoted to a mounting block of the fixing frame and rests against the running belt, and a cap rotatably covered to a top of the wheel. The cap has a through hole engaged with the mounting block and is capable of moving along a direction substantially perpendicular to a running direction of the belt at a contact position with the wheel. An elastic element is mounted between the mounting block and an inner side of the through hole and compressed by the moved cap to store an elastic force which releases to bring the wheel to press the running belt away from the mounting block for compensating a tensile force of the running belt.

### BACKGROUND OF THE INVENTION

1. Field of the Invention

The present invention relates to a drive mechanism, and particularly to a belt drive mechanism with belt tensioner.

2. The Related Art

Belt tensioners are generally well known devices that have been used previously in many belt-drive systems. It is conventional practice to use a tensioner to apply a constant belt-tensioning force, which compensates for increases in belt length due to wear and other factors. U.S. Pat. No. 4,473,362, for example, teaches a belt tensioner that has a fixed structure and a pivoted structure eccentrically mounted on the fixed structure by means of a pivot assembly. The pivoted structure has a belt-engaging pulley rotationally mounted thereon. A coil spring surrounds the pivot assembly and has its ends connected between the fixed and pivoted structures so as to bias the pivoted structure in a belt take-up direction. As the pivoted structure moves from a position of minimum belt take-up to a position of maximum belt take-up, the biasing force of the spring decreases gradually. If this varying spring force is over the range of tensioner movement, then the constant belt tension will be maintained by the tensioner. However, such structure of the tensioner in described above is complicated and difficult to manufacture and assemble.

### SUMMARY OF THE INVENTION

Accordingly, an object of the present invention is to provide a belt drive mechanism with belt tensioner. The belt drive mechanism with belt tensioner has a driving pulley pivoted to a fixing frame, a driven pulley pivoted to the fixing frame and driven to rotate by the driving pulley with a belt wrapping thereon, and a tensioner. The tensioner has a wheel pivoted to a mounting block of the fixing frame and resting against the running belt, and a cap rotatably covered to a top of the wheel. The cap has a through hole engaged with the mounting block and is capable of moving along a direction substantially perpendicular to a running direction of the belt at a contact position with the wheel. An elastic element is mounted between the mounting block and an inner side of the through hole and compressed by the moved cap to store an elastic force which can be released to bring the wheel to press the running belt away from the mounting block for compensating a tensile force of the running belt.

As described above, the wheel is pivoted to the fixing frame. The cap is coupled with the wheel and moves along the direction substantially perpendicular to a running direction of the belt at a contact position with the wheel. The elastic element received in the through hole can release the stored elastic force to bring the wheel to press the belt for compensating the decreasing tensile force of the running belt, which guarantees the steady transmission of the belt drive system. Furthermore, the structure of the tensioner simplifies the manufacture and assembly, and reduces the occupied space.

### BRIEF DESCRIPTION OF THE DRAWINGS

The present invention will be apparent to those skilled in the art by reading the following description thereof, with reference to the attached drawings, in which:

FIG. 1 is an exploded, perspective view of a belt drive mechanism with belt tensioner of an embodiment in accordance with the present invention;

FIG. 2 is a perspective view of a cap of the belt drive mechanism with belt tensioner shown in FIG. 1; and

FIG. 3 is an assembled, perspective view of the belt drive mechanism with belt tensioner shown in FIG. 1.

### DETAILED DESCRIPTION OF THE PREFERRED EMBODIMENT

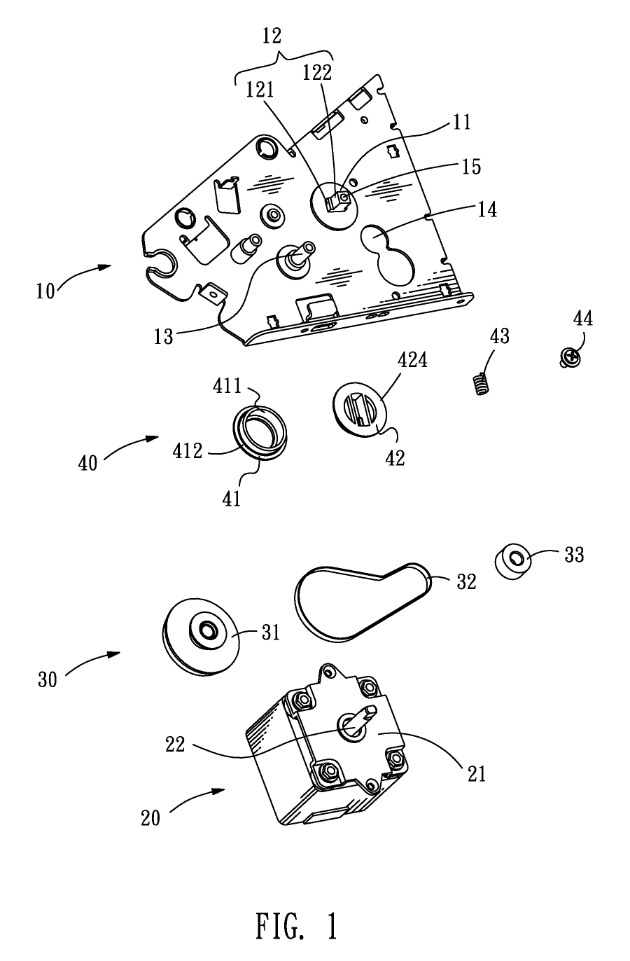

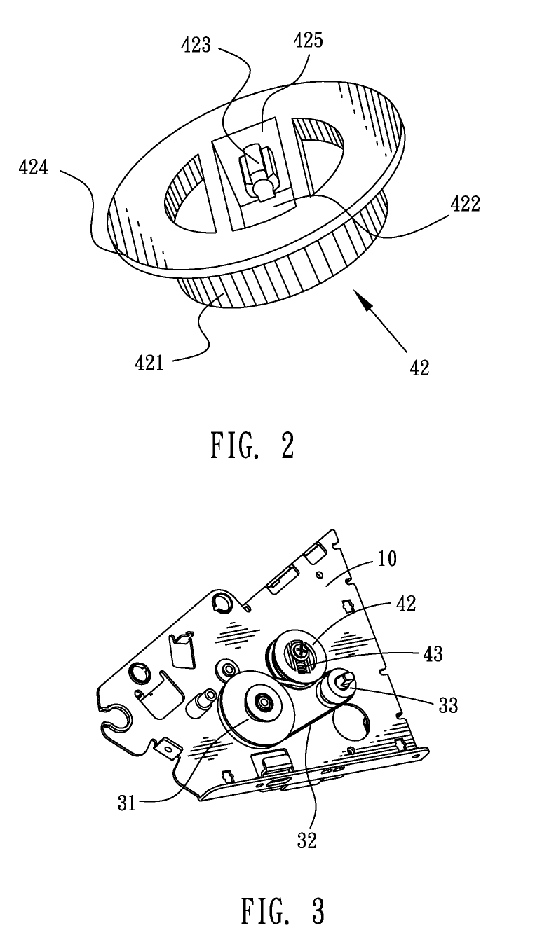

Referring to the drawings in greater detail, and first to FIGS. 1-3, the embodiment of the invention is embodied in a belt drive mechanism with belt tensioner. The belt drive mechanism with belt tensioner may be applied on a scanning apparatus (not shown) and comprises a driving element 20 mounted to a fixing frame 10 of the scanning apparatus, a convey element 30, and a tensioner 40.

The fixing frame 10 may be manufactured by a plate and has a pivot 13, a mounting opening 14 spaced away from the pivot 13 with a predetermined distance, and a circular protruding platform 11. The platform 11, the pivot 13 and the mounting opening 14 are located to form a substantially acute triangle shape. A center of a top of the platform 11 has a rectangular mounting block 12. The mounting block 12 has a cross-section length of an upper portion 122 thereof along a transverse direction which is substantially parallel to a line formed by the pivot 13 and the mounting opening 14, less than that of a lower portion 121 thereof. The upper portion 122 of the mounting block 12 has a fixing hole 15 for fixing the tensioner 40.

The driving element 20 has a motor 21, and a rotating shaft 22 projecting outside the motor 21. The motor 21 is fixed to a bottom side of the fixing frame 10 opposite to the platform 11. The rotating shaft 22 passes through the mounting opening 14 and projects outside a top side of the fixing frame 10.

The conveying element 30 has a driven pulley 31, a driving pulley 33 and a belt 32 wrapped around the driven pulley 31 and the driving pulley 33. The driven pulley 31 is pivoted to the pivot 13. The driving pulley 33 is fixed to the rotating shaft 22 of the driving element 20 and forced to rotate with the rotating shaft 22.

The tensioner 40 has a wheel 41, and a cap 42 mounted to a top of the wheel 41. The wheel 41 has a cylindrical body 411 and a flange 412 extended outwards from a bottom edge of the body 411. In this embodiment, the bottom edge of the body 411 is extended inwards a distance for increasing contact area between the wheel 41 and the platform 11 when the wheel 41 is mounted to the fixing frame 10. The cap 42 has cylinder 421 for rotatably inserting into the body 411, and a stopping plate 424 extended perpendicularly and outwardly from an upper edge of the cylinder 421 to show a ring shape. The stopping plate 424 has an outer border dimension thereof substantially same as that of the flange 412, for blocking the running belt 32 which rotates the wheel 41. The cylinder 421 has a rectangular through hole 422 at a middle thereof and passing through a top surface and a bottom surface thereof. The through hole 422 has a cross-section width substantially same as the transverse length of the upper portion 122 of the mounting block 12. A middle portion of a short inner side 425 of the through hole 422 is extended inwards to form a positioning pillar 423, spaced away from an opposite short inner side of the through hole 422.

Please refer to FIG. 3, in assembly, the cylinder 421 is inserted into the body 411, and the wheel 41 is rotated with respect to the cap 42. An elastic element 43, such as a spring, is provided to mount to the positioning pillar 423. After the mounting block 12 inserted into the through hole 422 from a bottom direction and fixed with the cap 42 together by a fixing element 44, such as a screw, engaged with the fixing hole 15, the spring 43 is restrained between the mounting block 12 and the short inner side 425 of the through hole 422. The belt 32 is against the body 411 of the wheel 41 in use and stopped between the flange 412 and the stopping plate 424 for preventing from falling off. When the drive mechanism with belt tensioner is in work, the belt 32 is running and pushes the wheel 41 moves along a lengthwise direction substantially perpendicular to the line formed by the pivot 13 and the mounting opening 14, with respect to the fixing frame 10. Correspondingly, the cap 42 is moved to compress the spring 43. When a tensile force of the belt 32 decreases due to the belt 32 stretched in long-term usage or other factors, the elastic force stored in the spring 43 will release to drive the wheel 41 to press the belt 32 so as to compensate the tensile force of the belt 32.

As described above, the cylindrical wheel 41 is pivoted to the mounting block 12 of the fixing frame 10. The cap 42 coupled with the wheel 41 is fixed to the mounting block 12 and capable of moving lengthwise with respect to the running belt 30. The spring 43 received in the through hole 422 can release the stored elastic force to bring the wheel 41 to press the running belt 32 for compensating the decreasing tensile force of the running belt 32, which guarantees the steady transmission of the belt drive system. Furthermore, the structure of the tensioner 40 is simple and compact, which is easy to manufacture and assemble, and occupies a relatively small space.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A belt drive mechanism with belt tensioner, comprising:
a fixing frame;
a driving pulley pivoted to the fixing frame;
a driven pulley pivoted to the fixing frame and driven to rotate by the driving pulley with a belt wrapping thereon; and
a tensioner having a wheel pivoted to a mounting block of the fixing frame and resting against the running belt, and a cap rotatably covered to a top of the wheel, the cap having a through hole engaged with the mounting block and capable of moving along a direction substantially perpendicular to a running direction of the belt at a contact position with the wheel, an elastic element mounted between the mounting block and an inner side of the through hole and compressed by the moved cap to store an elastic force which can be released to bring the wheel to press the running belt away from the mounting block for compensating a tensile force of the running belt.

2. The belt drive mechanism with belt tensioner as claimed in claim 1, wherein the wheel has a cylindrical body and a flange extended perpendicularly from an outer edge of the body adjacent to the fixing frame for blocking the running belt.

3. The belt drive mechanism with belt tensioner as claimed in claim 2, wherein the fixing frame has a portion protruded outwards to form a circular platform for holding the wheel, the mounting block is protruded from a center of the platform.

4. The belt drive mechanism with belt tensioner as claimed in claim 2, wherein the cap has a cylinder rotatably inserted into the body of the wheel, the through hole is formed at the cylinder.

5. The belt drive mechanism with belt tensioner as claimed in claim 4, wherein a top edge of the cylinder is protruded circumferentially to form a stopping plate of ring shape for blocking the running belt.

6. The belt drive mechanism with belt tensioner as claimed in claim 1, wherein the inner side of the through hole is protruded along the direction substantially perpendicular to the moving direction of the cap to form a positioning pillar for positioning the elastic element.

7. The belt drive mechanism with belt tensioner as claimed in claim 6, wherein the elastic element is a spring.

8. The belt drive mechanism with belt tensioner as claimed in claim 1, wherein the through hole is rectangular and engages with the rectangular mounting block of the fixing frame.

9. The belt drive mechanism with belt tensioner as claimed in claim 8, wherein an upper portion of the mounting block has a cross section length substantially perpendicular to the moving direction of the cap, less than that of a lower portion of the mounting block and substantially same as that of the through hole.
